(19) United States
(12) Patent Application Publication
(10) Pub. No.: US 2021/0146385 A1
(43) Pub. Date: May 20, 2021

(54) ROTATION DETECTION IN A HYDRAULIC DRIVE ROTATING TANK CLEANING SPRAY NOZZLE

(71) Applicant: Spraying Systems Co., Wheaton, IL (US)

(72) Inventors: Ken Dan Meyfroodt, Brugge (BE); Lieven Wulteputte, Melle (BE)

(21) Appl. No.: 16/950,236

(22) Filed: Nov. 17, 2020

Related U.S. Application Data
(60) Provisional application No. 62/937,519, filed on Nov. 19, 2019.

(51) Int. Cl. B05B 3/06; B05B 12/00

(52) U.S. Cl. CPC B05B 3/06; B05B 12/006

(57) ABSTRACT

An apparatus is described herein that includes an elongate arm and a rotating nozzle rotationally coupled to an end of the elongate arm. An electronic processor is communicatively coupled to a communication interface of an in-line pressure sensor of a liquid feed channel from a pump providing a fluid that both drives rotation of the rotating nozzle and cleans an interior surface of a vessel. The electronic processor analyzes a digitized measured pressure signal data stream provided by the pressure sensor to provide a real-time indication of rotational status of the rotating nozzle during a cleaning operation of the interior surface of the vessel.

### CROSS-REFERENCE TO RELATED APPLICATIONS

This application claims the benefit of U.S. Provisional Application No. 62/937,519, filed Nov. 19, 2019, which is expressly incorporated by reference in its entirety, including any references contained therein.

### TECHNICAL FIELD

The present invention relates generally to (or other visually obstructed surface) cleaning systems and apparatuses, and more particularly to internal surface cleaning systems that include a rotating spray head assembly to which a rotating nozzle assembly is attached, where the rotating nozzle assembly contains one or more spray nozzles. The rotating spray head assembly is disposed at an end of an elongate arm that is inserted into a tank or other enclosure (e.g. a pipe) and arranged to rotate to provide a full spraying coverage of an inside surface of the tank or enclosure.

### BACKGROUND

Fluid containment tanks are utilized in a multitude of industrial processes such as food and chemical manufacturing and processing, pharmaceutical manufacturing, wine preparation, material fermentation, and so on. It is often critical to ensure that the interior of the tank is free of unwanted debris and contaminants.

Unwanted contaminants in the tank, or other enclosed area (such as a pipe) may negatively impact the quality of the finished product being processed or manufactured. Moreover, the failure to adequately clean the tank interior can violate regulations relevant to certain industries such as pharmaceutical processing. Thus, it is common to clean the interior of such tanks at certain intervals, e.g., after each process batch, to ensure product quality and adherence to any relevant regulations.

One type of cleaning system employs a tool inserted into a tank. The inserted tool is placed permanently or temporarily within the tank and is typically sealed to the tank via a flange. A rod-like extension of the tool within the tank interior supports a rotary spray head.

Given the interest in monitoring and control of operation of cleaning systems of the type described above, there is a significant need to provide, without aid of visual observation of the inside of a vessel undergoing cleaning, assurance with a high degree of certainty that the rotary spray head assembly is operating properly.

A number of problems arise when the nozzle is not rotating properly. It may be necessary to repeat an incompletely/improperly performed cleaning cycle that often exceeds 30 minutes. In many cases substantial/costly cleaning materials are wasted. In a case where the rotation is not completely stopped, but is merely slowed, a non-optimal/reduced quality cleaning operation may occur.

Given the importance of efficient, complete cleaning of internal tank surfaces, a highly reliable and easily performed spray nozzle rotation monitoring system is desired.

### SUMMARY

In accordance with disclosed example structures and operation thereof, monitoring a rotating spray nozzle status during operation (and issuing a local and/or online alarm when rotation is slowed/stopped) is described herein. The described arrangement achieves the above-advantages without a need to place sensors inside the tank and without modifying the tank. As such, a tank cleaning operation may be certified as complete without a need to visually observe the inside tank surface (which may otherwise entail breaking sealed tank certificates). The described apparatus and method also provide a simplified way to add such monitoring to a tank with minimal physical modification of the tank cleaning apparatus.

Embodiments of the present invention provide an apparatus that includes a feed line providing a fluid under pressure from a fluid source and an elongate arm coupled to receive the fluid from the feed line. The apparatus further includes a rotary spray head assembly rotationally coupled to an end of the elongate arm. Rotation of a nozzle of the rotary spray head assembly is driven by the fluid from the feed line. The rotary spray head assembly incorporates a supplemental periodic fluid flow opening arranged to cause a periodic change in pressure of fluid within the feed line in accordance with a rotation of the nozzle in relation to the end of the elongate arm. Additionally, a pressure sensor is provided on the feed line and arranged to sense a pressure of fluid within the feed line, wherein the pressure sensor, in operation, senses the periodic change in pressure of fluid within the feed line. An electronic processor is communicatively coupled to a communication interface that facilitates receiving a pressure signal generated by the pressure sensor in accordance with the periodic change in pressure of fluid within the feed line, wherein the electronic processor is configured to process the pressure signal to render a rotational status determination for the rotary spray head assembly.

### BRIEF DESCRIPTION OF DRAWINGS

FIG. 1 is a schematic depiction of an illustrative containment tank comprising a cleaning apparatus with a sensor assembly usable in accordance with embodiments of the disclosure;

FIG. 2 is an outline perspective view of an exemplary rotating spray nozzle including a drilled hole facilitating generating a repeating pressure drop during operation of the properly functioning rotating spray nozzle;

FIG. 3 is a graphical depiction of an exemplary output signal rendered by an in-line pressure sensor between a pump and a rotating nozzle receiving a fluid provided by an outlet port of the pump of the cleaning apparatus of the system illustrated in FIG. 1;

FIG. 4 is a graphical depiction of an exemplary frequency spectrum rendered by performing a fast Fourier transform (FFT) on the output signal of the in-line pressure sensor such as the one graphically depicted in FIG. 3; and

FIG. 5 is a schematic depiction of an alternative illustrative containment tank comprising a cleaning apparatus with a two-sensor assembly arranged before and after a pipe-section having a reduced flow channel to facilitate detecting a flow change arising from the periodic rotation of the rotating spray nozzle.

While the invention is susceptible of various modifications and alternative constructions, certain illustrative embodiments thereof have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE DRAWINGS

Illustrative examples of an apparatus are now described that address a need to provide a non-intrusive and easily installed and operated sensor/monitor to ensure a rotating head spray nozzle is rotating properly in a visually obstructed environment (e.g. a tank, a pipe, etc.). The rotating head spray nozzle is, for example, rotationally coupled to an end of an elongate arm to facilitate rotating the rotary spray head assembly on an axis of rotation defined by the rotational coupling between the rotary spray head assembly and the elongate arm. The illustrative examples utilize an in-line pressure sensor of a fluid source (used to both clean the tank and mechanically drive the rotating head spray nozzle in operation) to continuously measure a pressure of fluid flowing to an outlet point (or points) at the rotating head spray nozzle. The pressure signal rendered by the in-line pressure sensor is analyzed, in real-time to render an output indicative of a current status of the rotating head spray nozzle with respect to rotation, and/or rotation rate.

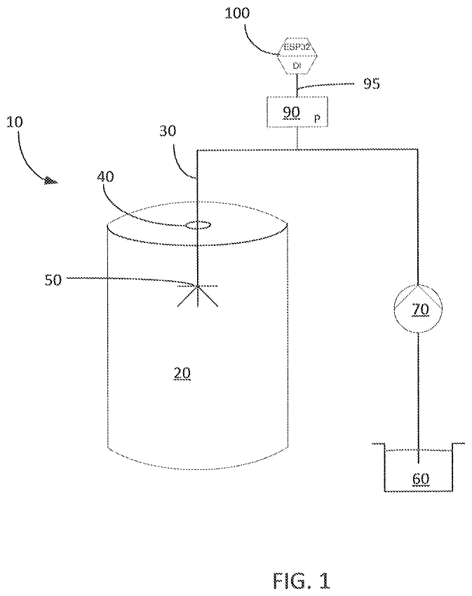

Referring to FIG. 1, an illustrative cleaning apparatus 10 which has particular utility in cleaning an interior surface of a tank 20 is depicted. The cleaning apparatus 10 comprises an elongate tubular portion 30 that extends into the tank 20. An interior surface of the tank 20 is sealed from an external environment via an annular seal 40 at which the elongate tubular portion 30 of the cleaning apparatus 10 enters the tank 20.

During a cleaning process, the cleaning apparatus 10 projects a cleaning fluid in one or more streams against the interior surface of the tank 20. While projecting the streams against the walls of the tank 20, the cleaning apparatus 10 progressively varies a location of impingement of the streams on the interior surface of the tank 20 so as to eventually treat (clean, rinse, coat, etc.) substantially the entire interior surface of the tank 20. The manner in which the point(s) of impingement on the interior surface of the tank 20 are controlled is carried out in any of a vast spectrum of control schemes.

Of particular interest in the context of the provided examples, a nozzle 50 is rotatably mounted at a distal end of the elongate tubular portion 30 to affect a cleaning of the interior surface of the tank 20 in the aforementioned manner. In accordance with illustrative example, rotation of the nozzle 50 is driven by forces generated by a force of the fluid passing through the elongate tubular portion 30 and exiting at the nozzle 50.

With continued reference to FIG. 1, the aforementioned fluid is drawn from a reservoir 60 by a pump 70. In accordance with the illustrative example, the fluid passes from an outlet of the pump 70 into a channel 80 connected to an inlet port of the cleaning apparatus 10. Additionally, a pressure sensor 90 is disposed on the channel 80 to sense a pressure of the fluid within the channel 80. The pressure sensor 90 provides an output pressure signal via a communication link 95 to a processing unit 100 (e.g. a low-power microcontroller or any other suitable programmable processing device) programmed/configured with a non-transitory computer readable medium including computer-executable instructions that, when executed, facilitate processing a pressure signal data stream rendered from a signal provided via the communication link 95. As will be appreciated, the form of the link 95 may be any of a wide variety of wired/wireless communication link technologies including hardwired, Wi-Fi, Bluetooth, mobile wireless (e.g. 5G), etc. The above-identified elements depicted in FIG. 1 are discussed in detail herein below.

The illustrative examples provided herein rely upon a configuration of the nozzle 50 such that a pressure variation, detectable by the pressure sensor 90, is generated in the channel 80 at least once for every rotation of the nozzle 50 during operation of the cleaning apparatus 10. The detectability of the pressure variation, in accordance with illustrative examples provided herein, relies upon a configured magnitude of the flow variation out of the nozzle 50 that renders the periodic pressure variation observed/recorded by the pressure sensor 90. On the other hand, a chosen magnitude of the flow variation is kept sufficiently low to avoid excessive mechanical shock to the nozzle 50 and/or cleaning efficacy.

With specific reference to the nozzle 50, in illustrative examples, such as the system depicted in FIG. 1, the nozzle 50 is a hydraulically driven rotating nozzle that is physically designed to induce a flow fluctuation (e.g. increase as a result of an exposed outlet orifice) of less than 5 percent of the normal flow rate (without the fluctuation) at least once during each rotation of the nozzle 50 during a cleaning operation. A quantity of flow fluctuations per rotation and a rotation period have known/configurable values. For example, the nozzle 50 may be physically configured to produce three (3) fluctuations per rotation; and the nozzle 50 may be tuned/configured to operate at one rotation every 5 seconds (12 RPM), resulting in 36 pressure fluctuations per minute (0.6 Hz). While a single pressure fluctuation per rotation will suffice, multiple fluctuations per rotation may be preferable to improve rotation detection responsiveness and detection accuracy (by increasing the rate of producing detection events during operation of the nozzle 50) for relatively long rotation periods. For example, sufficient fluctuation-producing features are incorporated into the nozzle 50 so as to produce at least one fluctuation every two seconds. While the type of fluctuation-producing feature incorporated into the nozzle 50 is not a primary issue in the broadest sense of the disclosure, in an example arrangement a hole is drilled into a wall of the nozzle 50 to allow additional fluid to be emitted from the hole during a small fraction of a full physical rotation of the nozzle 50. By way of example, for the Spraying Systems MINI-ROKON nozzle, 3 holes of 0.6 mm were formed/drilled in the rotating element) to produce a 50 mBar (<1 PSI) pressure drop 3 times per rotation period.

Referring to the pressure sensor 90, in an illustrative example, the pressure sensor 90 is a relatively fast (less than 5 msec rise time) and high resolution (e.g. 14 bit) pressure transducer with a sensing interface placed in direct contact with the fluid within the channel 80 of the supply line from the pump 70 to the nozzle 50. The pressure sensor 90 provides, in an illustrative example, a digitized pressure signal value to the processing unit 100 via the link 95 at a rate of 1 digitized pressure sample every 20 milliseconds (50 hz). However, the sampling rate will differ in accordance with various illustrative examples and cleaning applications. In all instances, the sampling rate should be sufficient to facilitate frequency domain analysis of the digitized pressure signal sample stream to distinguish between the nozzle rotation detection-facilitating pressure fluctuations and background pressure signal noise (e.g., pressure fluctuations induced by operation of the pump 70). In a particular example, the pressure sensor 90 is a TE Connectivity low power TE M3200 with I2C connection to avoid adding signal noise.

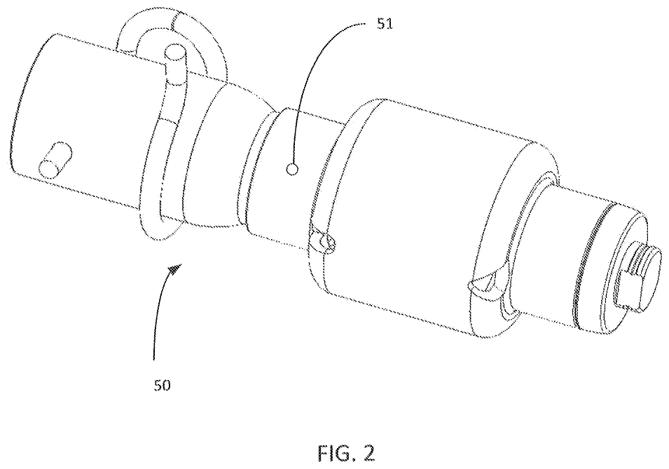

Turning briefly to FIG. 2, an outline perspective view is provided of an exemplary rotating spray nozzle (nozzle 50) including a drilled hole 51. In this illustrative example, the drilled hole 51 is positioned at a point on the nozzle 50 that will facilitate a periodic release of fluid through the drilled hole 51 opening that, in turn, generates a repeating pressure drop in the fluid line during operation of the properly functioning rotating spray nozzle. That pressure drop is sensed by the pressure sensor 90.

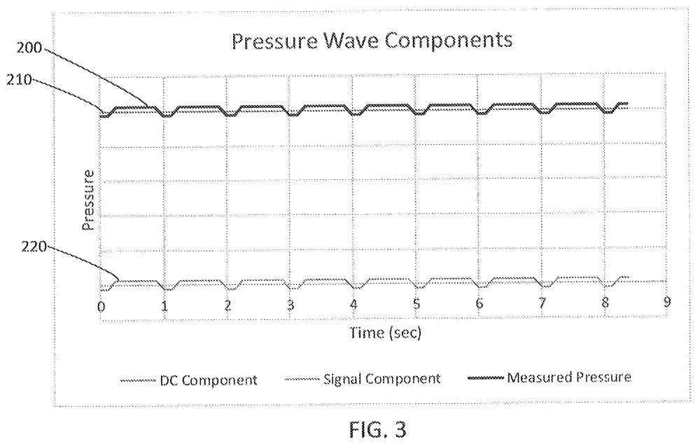

Regarding the operation of the processing unit 100, the digitized signal steam is received and stored in a historian database. The induced pressure fluctuations may be directly analyzed to identify/detect rotation from a signal steam of the type depicted, by way of example in FIG. 3. In that regard, a measured pressure signal 200 is received by the processing unit 100. A constant/DC component (long-term average) pressure 210 is subtracted from the measured pressure signal 200 to render an induced pressure fluctuation signal 220. The processing unit 100 may analyze either the measure pressure signal 200 or the induced pressure fluctuation signal 220 to identify expected pressure fluctuations during monitoring the rotation status of the nozzle 50 during operation of the system depicted in FIG. 1.

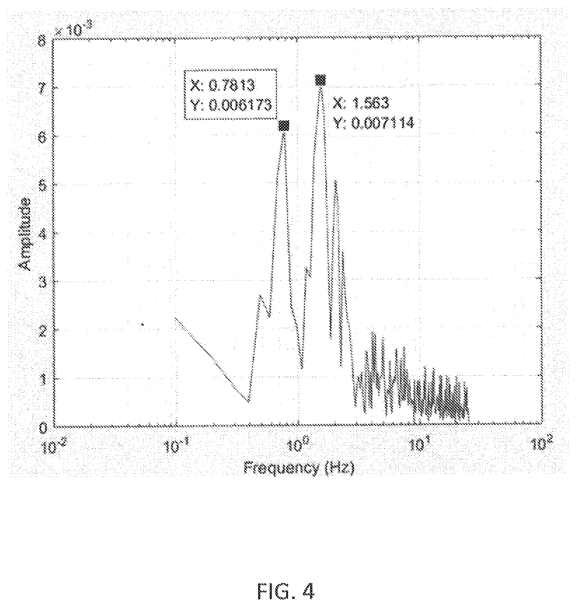

However, in practice, and given the presence of signal noise induced by operation of the pump 70, a more robust detection scheme involves the processing unit 100 performing a frequency domain analysis of the digitized signal stream to identify/detect a signature peak within the frequency domain output corresponding to the periodic pressure fluctuations induced by rotation of the nozzle 50. By way of example, the processing unit 100 performs a fast Fourier transform (FFT) on a 256 sample window (approximately 5 seconds) in a known manner. An exemplary output rendered by the FFT analysis of the digitized signal stream provided during operation of the nozzle 50 is presented in FIG. 4. With continued reference to FIG. 4, the processing unit 100 performs the FFT directly on the digitized measured pressure signal data stream (see measured pressure signal 200) since the “DC” component is extracted during the FFT operation itself. After performing the FFT, which renders frequency domain signal strength/power as a function of frequency, the processing unit examines the frequency spectrum to identify/confirm the presence of signal peaks at particular frequencies corresponding to the expected pressure fluctuations during operation of the nozzle 50. The frequency peak (or peaks—in the case of multiple harmonics) is analyzed by the processing unit 100 to render an operating rotation period/rate of the nozzle 50 in operation in real time (e.g. every 5 seconds). In the illustrative example, the peaks indicate that the nozzle is rotating at approximately 16 rotations per minute (in a three-hole nozzle design that produces 48 fluctuations per minute or 0.8 Hz). It is further noted that a second peak at 1.6 Hz is a second harmonic arising from a relatively square wave shaped signal—as opposed to a sine wave that would render a single peak at 0.8 Hz.

While the above example does not pre-process the input signal prior to performing the FFT, in the case of a slowly changing source pressure, it is desirable to apply a line fitting (first order) operation to the pressure sensor signal to remove the observed “slowly changing” signal component prior to performing the FFT.

While certain illustrative examples are provided above, it is noted that a variety of variations on the illustrative examples are contemplated. For example, the following variations are contemplated to potentially improve detecting the pressure “ripple” in the supply line to the rotating nozzle arising from the above described physical system during rotation of the nozzle 50. The holes within the nozzle may be enlarged to provide a greater flow change. Such increase may be necessary to account for various physical configurations of the pipes feeding the nozzle 50.

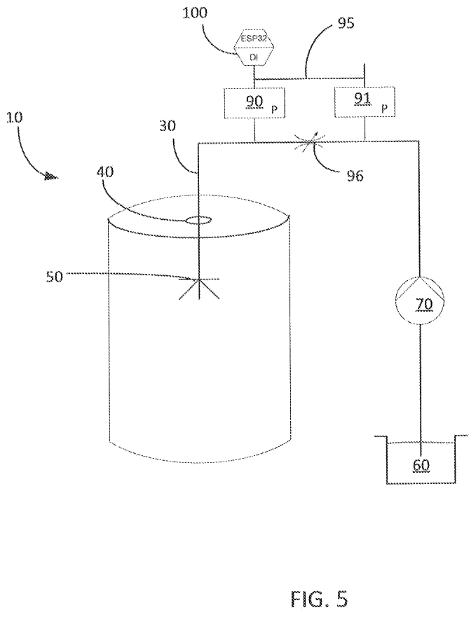

Furthermore, a further physical sensor arrangement is provided in FIG. 5 that relies upon measuring a change in a differential pressure between the pressure sensor 90 and a second pressure sensor 91 that measures a pressure before a localized narrowing 96 of the supply line between the pump 70 and the nozzle 50. While fluid is flowing, a non-zero pressure difference is registered between the pressure values sensed two sensors 90 and 91. This adds an additional piece of information (i.e. flow rate) that enhances the functionality of the system. Regarding the sensing of the pressure “ripple”, the sensing arrangement relies upon a presence of a detectable pressure change that occurs within a relatively short time period. Thus, a worst case scenario involves a very small (essentially zero) relative pressure change arising from a slowly changing flow rate associated with the nozzle 50 rotation cycle encountering/leaving a rotation position associated with an increased flow rate (see, e.g., FIG. 2 where a drilled hole 51 in a casing of the nozzle 50 periodically leads to increased flow during operation). In such case, the sensor 90 would not provide a pressure ripple. Also, an oversized pump supply may also give a very small ΔP/ΔQ at the operating (DC) pressure point hence the flow change cannot be detected with a single pressure sensor. Such potential issues may be addressed by the two sensor (and flow channel restriction) arrangement depicted in FIG. 5.

Another potential variation to the physical structures of the system is increasing a frequency of the pressure fluctuations. If a pressure fluctuation event rate of, for example, 0.05 Hz is too low (e.g. the pressure line has too much noise or a longer measuring time is required to provide a sufficient quantity of samples for performing the FFT), then more openings (or other discontinuities) are incorporated into the nozzle 50 to ensure a sufficient detectable event rate.

Other variations involve modifying the operation/signal processing performed by the processing unit 100. For example, instead of looking for a single peak in the frequency response, searching the frequency response for multiple peaks (e.g. both a first and a second harmonic that are present to reduce the value of a possible external third spike on another frequency arising from another signal/pressure fluctuation source).

Additionally, a signal-to-noise ratio (SNR) property is changed to make the absolute measurement relative, making a relative good/bad threshold. In general, the detectability of rotation of the nozzle 50 improves with increases in the size of the pressure change and increases in the rise/fall slopes of the pressure “ripple”. Additionally, filtering out known external frequency sources may also be performed to improve detectability and eliminate such sources prior to performing analysis of the frequency domain data to determine the presence of signature peaks associated with proper operation of the nozzle 50.

Additionally, thresholds for peak frequency detection may be adjusted to ensure against false positives/negatives regarding detecting a non-rotating nozzle. Such thresholds may be established by “training” runs of the system where operation of the nozzle 50 can be confirmed by direct observation (as opposed to later operation where the actual operation cannot be visually observed).

Yet another variation/enhancement involves the processing unit tracking SNR over an entire cleaning run to establish a threshold. For example, during an entire cleaning run of the system depicted in FIG. 1, many signal-to-noise values are determined by the system. Such information is processed offline to fine-tune the system to ensure against false positives (i.e. the pressure ripples are not detected). Additionally, an engineer may manually configure a threshold level for detecting proper operation (rotation) of the nozzle 50 based upon, for example, update information provided by an external source (e.g. a cloud-based maintenance service).

Additionally, it is contemplated that the processing unit 100 will use previously recorded signature signal profiles (e.g. identified peak frequencies and levels in the FFT of the pressure signal). In such case, after using a provided signature, the user may confirm that the provided signature was indeed good (or reject its use)—in a “machine learning” processing environment/approach to configuring detection algorithms. A compare operation may be used to ensure against excessively changing (a limit to a percentage of change) detection threshold parameters for proper operation of the nozzle 50.

It is further contemplated that good/bad detection thresholds and signatures associated with good/bad operation will be acquired, classified, and aggregated to provide a variety of field-tested reliable threshold parameter sets and signatures for use by particular applications (e.g., particular pressures, flow rates, fluid viscosity, spray nozzle model, drilled holes, etc.).

Although the accompanying discussion has referred to generally to the cleaning of closed tanks and enclosures, it will be appreciated that the invention is not so limited. Alternative configurations of the cleaning apparatus include: linear actuated nozzles, retractable lances, tube and pipe cleaning units, sewers, etc.—anywhere a rotating end piece that carries one or more spray nozzles is not visible during a cleaning operation. One or more of the described embodiments may be useful when seeking validation of functional operation.

It will be appreciated that the foregoing description relates to examples that illustrate a preferred configuration of the cleaning system. However, it is contemplated that other implementations of the invention may differ in detail from foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus comprising:
a feed line providing a fluid under pressure from a fluid source;
an elongate arm coupled to receive the fluid from the feed line;
a first pressure sensor provided on the feed line and arranged to sense fluid pressure within a first section of the feed line;
a rotary spray head assembly rotationally coupled to an end of the elongate arm, wherein rotation of a nozzle of the rotary spray head assembly is driven by the fluid from the feed line, wherein the rotary spray head assembly incorporates a supplemental periodic fluid flow opening arranged to cause periodic changes in fluid pressure within the feed line in accordance with a rotation of the nozzle in relation to the end of the elongate arm, and wherein the periodic changes in fluid pressure are sensed by the first pressure sensor at the first section of the feed line; and
an electronic processor communicatively coupled to a communication interface that facilitates receiving a first pressure signal generated by the first pressure sensor in accordance with the periodic changes in fluid pressure at the first section of the feed line, wherein the electronic processor is configured to process the first pressure signal in accordance with rendering a rotational status determination for the rotary spray head assembly.

2. The apparatus of claim 1 wherein the supplemental periodic fluid flow opening comprises a hole in a casing of the rotary spray head assembly.

3. The apparatus of claim 1 wherein the supplemental periodic fluid flow opening comprises multiple holes in a casing of the rotary spray head assembly.

4. The apparatus of claim 3 wherein the multiple holes are positioned to provide a single periodic fluid release during each rotation of the nozzle.

5. The apparatus of claim 3 wherein the multiple holes are positioned to provide multiple periodic fluid releases during each rotation of the nozzle.

6. The apparatus of claim 1 further comprising:
a second pressure sensor provided on the feed line and arranged to sense fluid pressure within a second section of the feed line downstream from the first section of the feedline,
wherein the electronic processor is communicatively coupled to receive a second pressure signal generated by the second pressure sensor in accordance with the periodic changes in fluid pressure at the second section of the feed line, and wherein the electronic processor is configured to process the second pressure signal in accordance with rendering the rotational status determination for the rotary spray head assembly, and
wherein the feed line has a localized narrowing between the first section and second section of the feed line.

7. The apparatus of claim 6 wherein the electronic processor is configured to render the rotational status determination based upon a differential pressure analysis of the first pressure signal and the second pressure signal over a period of time.

8. The apparatus of claim 1 wherein the electronic processor is configured to detect a pressure ripple arising from rotation of the nozzle of the rotary spray head.
